(19) United States
(12) Patent Application Publication
(10) Pub. No.: US 2024/0353440 A1
(43) Pub. Date: Oct. 24, 2024

(54) SENSOR ASSEMBLY

(71) Applicant: Apple Inc., Cupertino, CA (US)

(72) Inventors: Aidan N. ZIMMERMAN, Sunnyvale, CA (US); Ivan S. MARIC, San Francisco, CA (US); Nicholas C. SOLDNER, Mountain View, CA (US); Jose A. RIOS, Danville, CA (US); Stergios ROUMELIOTIS, Los Altos Hills, CA (US); David S. GRAGNOLATI, San Francisco, CA (US)

(21) Appl. No.: 18/685,492

(22) PCT Filed: Aug. 24, 2022
(86) PCT No.: PCT/US2022/041417

§ 371 Date: Feb. 21, 2024

Related U.S. Application Data
(60) Provisional application No. 63/244,158, filed on Sep. 14, 2021.

(51) Int. Cl. G01P 1/02; G02B 27/00; G02B 27/01; G06F 3/01

(52) U.S. Cl. CPC G01P 1/023; G02B 27/0093; G02B 27/017; G06F 3/012; G02B 2027/014; G02B 2027/0187

(57) ABSTRACT

A sensor assembly for a head-mountable device, the sensor assembly comprising: a flex circuit, an inertial measurement unit coupled to the flex circuit, an enclosure disposed around the inertial measurement unit and a portion of the flex circuit, to define a sealed volume containing the inertial measurement unit and the portion of the flex circuit. Thereby, a head-mountable device can securely support sensors in a manner that maintains their positions and orientations over time and isolates the sensors from an external environment. The sensor can be mounted within a sealed enclosure while maintaining an operable connection to the sensor. The sensor assemblies provides high robustness during the entirety of the service life of the head-mountable device without placing strain on the sensors themselves. The seal of the enclosure can isolate the sensor from external influences by preventing ingress of elements through the case and plate.

### CROSS-REFERENCE TO RELATED APPLICATION

This application claims the benefit of U.S. Provisional Application No. 63/244,158, entitled “SENSOR ASSEMBLY FOR HEAD-MOUNTABLE DEVICE,” filed Sep. 14, 2021, the entirety of which is incorporated herein by reference.

### TECHNICAL FIELD

The present description relates generally to sensor assemblies, and, more particularly, to sensor assemblies for head-mountable devices.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a side view of a head-mountable device, according to some embodiments of the present disclosure.

FIG. 2 illustrates an exploded perspective view of a sensor assembly of the head-mountable device of FIG. 1, according to some embodiments of the present disclosure.

FIG. 3 illustrates a side sectional view of a sensor assembly, according to some embodiments of the present disclosure.

FIG. 4 illustrates a side sectional view of a sensor assembly, according to some embodiments of the present disclosure.

FIG. 5 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mounted displays, headsets, visors, smartglasses, head-up display, etc., can perform a range of functions that are managed by the components (e.g., sensors, circuitry, and other hardware) included with the wearable device. The head-mountable device can provide a user experience that is immersive or otherwise natural so the user can easily focus on enjoying the experience without being distracted by the mechanisms of the head-mountable device.

Many of the functions performed by a head-mountable device can be based, at least in part, on detections made by one or more sensors that are mounted on board the head-mountable device. Such sensors can provide information regarding, for example, the position, orientation, and/or movement of the head-mountable device and/or the user. It can be desirable to maintain the sensor in an enclosure that is protected from an external environment so that the sensor is not affected by influences that would alter its performance. However, some mounting systems can allow a sensor to be exposed to undesirable levels of temperature and/or humidity. Yet other mounting systems can place excessive strain on the sensor, which can be sensitive to such conditions and have diminished effectiveness thereafter.

Systems of the present disclosure can provide a head-mountable device that securely supports sensors that are isolated from an external environment within a sealed container and orientations over time and avoids applying excessive strain on the sensors, thereby protecting them from harm. The sensor can be mounted on a flex circuit or circuit board, which is rigidly secured within an enclosure, including for example a plate and a case. The case and the plate can be sealed together with the flex circuit extending there through (e.g., at an opening formed by sealing glue) to operably connected to another component.

Accordingly, the sensor assemblies described herein facilitate effective performance of sensors mounted therein. The sensor assemblies provides high robustness during the entirety of the service life of the head-mountable device without placing strain on the sensors themselves. The seal of the enclosure can isolate the sensor from external influences by preventing ingress of elements through the case and plate. The sensor assemblies further enable the mounting of sensors on a flex circuit, where desired.

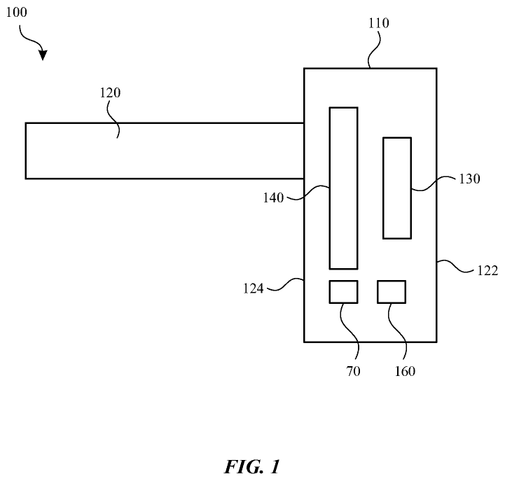

These and other embodiments are discussed below with reference to FIGS. 1-5. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110 that is worn on a head of a user. The frame 110 can be positioned in front of the eyes of a user to provide information within a field of view of the user. The frame 110 can provide nose pads or another feature to rest on a user's nose. The frame 110 can be supported on a user's head with the head engager 120. The head engager 120 can wrap or extend along opposing sides of a user's head. The head engager 120 can include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the head engager 120 can include multiple components to engage a user's head.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 100, as discussed further herein. While several components are shown within the frame 110, it will be understood that some or all of these components can be located anywhere within or on the head-mountable device 100. For example, one or more of these components can be positioned within the head engager 120 of the head-mountable device 100.

The frame 110 can include and/or support one or more cameras 130. The cameras 130 can be positioned on or near an outer side 122 of the frame 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 122. For example, a track or other guide can be provided for facilitating movement of the camera 130 therein.

The head-mountable device 100 can include displays 140 that provide visual output for viewing by a user wearing the head-mountable device 100. One or more displays 140 can be positioned on or near an inner side 124 of the frame 110. As used herein, an inner side 124 of a portion of a head-mountable device is a side that faces toward the user and/or away from the external environment.

A display 140 can transmit light from a physical environment (e.g., as captured by a camera) for viewing by the user. Such a display 140 can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

A physical environment relates to a physical world that people can sense and/or interact with without necessarily requiring the aid of an electronic device. A computer-generated reality environment relates to a wholly or partially simulated environment that people sense and/or interact with the assistance of an electronic device. Examples of computer-generated reality include mixed reality and virtual reality. Examples of mixed realities can include augmented reality and augmented virtuality. Some examples of electronic devices that enable a person to sense and/or interact with various computer-generated reality environments include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable device can have an integrated opaque display, have a transparent or translucent display, or be configured to accept an external opaque display (e.g., smartphone).

The head-mountable device 100 can include one or more sensors 70. The sensors 70 can be mounted to the frame 110 in a secure manner, as described further herein. Any number and type of sensors can be provided. For example, one or more of the sensors 70 can be or include an inertial measurement unit (“IMU”) that provides information regarding a characteristic of the head-mountable device 100, such as inertial angles thereof. For example, the IMU can include a six-degrees of freedom IMU that calculates the position, velocity, and/or acceleration of the head-mountable device 100 based on six degrees of freedom (x, y, z, θₓ, θ_{y}, and θ_{z}). The IMU can include one or more of an accelerometer, a gyroscope, and/or a magnetometer. Additionally or alternatively, the sensors 70 can detect motion characteristics of the head-mountable device 100 with one or more other motion sensors, such as an accelerometer, a gyroscope, a global positioning sensor, a tilt sensor, and so on for detecting movement and acceleration of the head-mountable device 100. The sensors 70 can provide data to a controller for processing. Such data can influence other operations of the head-mountable device 100, such as the information provided on the display 140.

It will be understood that the sensors 70 (e.g., IMUs) and associated assemblies can be coupled to and/or integrated with one or more other components of the head-mountable device 100. For example, one or more sensors 70 can be coupled to components that move relative to the frame 110 or other components of the head-mountable device 100. By further example, one or more sensors 70 can be coupled to one or more displays 140, the frame 110, and/or other components 160 of the head-mountable device 100 (e.g., controllers, input/output devices, and the like). Accordingly, by operating multiple sensors 70, the absolute and/or relative position and/or orientation of each of the associated components can be determined. For example, one or more (e.g., a pair of) displays 140 can move relative to each other and/or the frame 110 to be aligned with the eyes of the user, and sensors 70 coupled to each of the displays 140 can track such movement. By further example, the sensors 70 of separate head-mountable devices 100 (e.g., worn by different users) can share information so that each of the head-mountable devices 100 can determine the absolute and/or relative position and/or orientation of the other and optionally output corresponding information (e.g., visual information via displays 140) so the users can perceive each other's presence, for example in a shared CGR environment.

Solid state motion sensors, such as IMUs, can be affected by strain, temperature, and humidity. Over time, exposure to these influences can result in a wider and less predictable operating range over the life of the IMU. For example, devices relying on absolute measurement of orientation and/or acceleration using MEMS IMUs may require bounded changes in bias, axis orthogonality, and cross-axis sensitivity. Typically, these sensors are surface mounted on a rigid PCB and care is taken to choose PCB locations that minimize strain and temperature shift. However, for some more demanding applications this is not sufficient to extract all performance from the sensor.

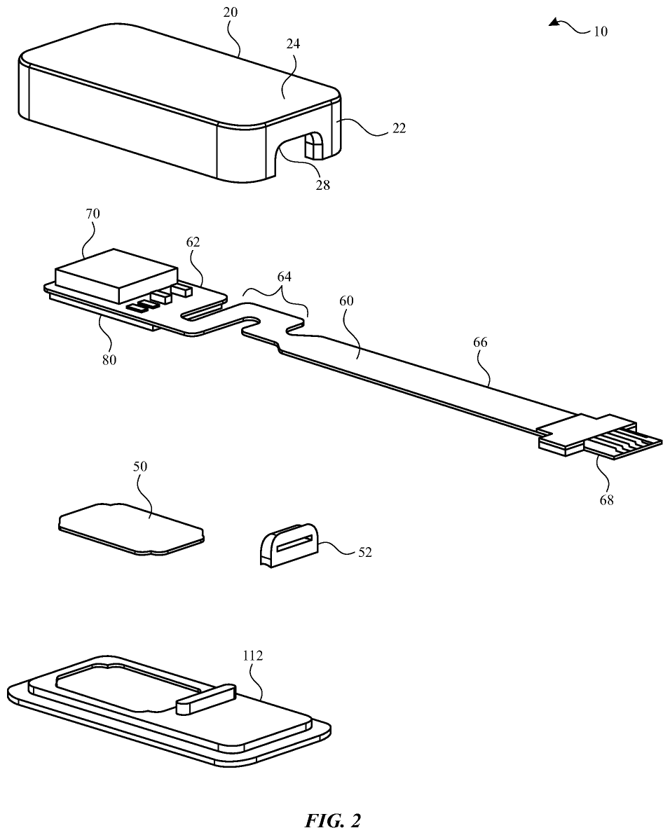

Referring now to FIGS. 2-4, a sensor assembly can be provided to securely support one or more sensors of a head-mountable device while simultaneously protecting the sensors from exposure to an external environment as well as forces applied to the assembly. It will be understood that the assembly described herein can be one of multiple assemblies and can include one or more other components of the head-mountable device. It will be further understood that a sensor assembly can be integrated into the head-mountable device and/or provided as a module thereto.

As shown in FIG. 2, a sensor assembly 10 can include a sensor 70 (e.g., IMU) housed within a protective case. A top case 20 of the sensor assembly 10 can be securely coupled to the bottom plate 112 or another component of the head-mountable device. For example, the bottom plate 112 can be part of, integrated with, and/or coupled to a frame and/or another component of the head-mountable device.

The sensor 70 can be coupled to a flex circuit 60. For example, the sensor 70 can be directly mounted to a surface of the flex circuit 60. Additionally or alternatively, the sensor 70 can be mounted to board that is directly or indirectly coupled to the flex circuit 60. The flex circuit 60 can, in turn, directly or indirectly couple the sensor 70 and/or the board to other components of the sensor assembly 10, such as the top case 20 and/or the bottom plate 112.

The sensor 70 can be implemented as an integrated circuit, such as one or more of an industry standard integrated circuit, an application-specific integrated circuit (ASIC), an application-specific standard product (ASSP), and the like. The sensor 70 can have a size and shape that is accommodated by the housing structure of the assembly and provides the desired performance characteristics. For example, the sensor 70 can be integrated with a wafer and/or board.

The one or more sensors 70 of the sensor assembly 10 can be mounted to the flex circuit 60 that operably connects the sensors 70 of the sensor assembly 10 to each other and/or other components. As used herein, “flexible circuit” or “flex circuit” is a structure that includes a conductive layer, an insulation layer, and optionally a substrate layer. A flex circuit can be provided in electrical communication with at least one electrode, terminal, and/or connector. A flex circuit forms circuitry that includes a pattern of conductors of the conductive layer typically in the form of pads, which are typically formed on a surface of an insulating material of the insulation layer. Such circuitry is typically metallic, such as of a copper or copper alloy. In general, a flex circuit is thin, having a total thickness of from about 1 mm to about 30 mm. A flex circuit is generally flexible, such that it can conform to contours of other components. A flex circuit may be any suitable size and constructed in any suitable shape. For example, the size of a flex circuit may be determined by the power requirements of the components connected thereto, the conductivity of the flex circuit, the distance between operably connected components, or any other suitable criteria. It will be understood that, additionally or alternatively, a cable or other conductive material surrounded by an insulating layer can be provided. Such a cable can be connected via a connector and/or a hot bar and/or wire bond to one or more boards and/or other electronic components.

Providing operable connections to and from the sensors 70 via a flex circuit 60 can facilitate such connections while occupying little space within the head-mountable device. Additionally, a flex circuit 60 can conform and bend around other components of the head-mountable device. These features can help the head-mountable device maintain a low weight and small size.

The flex circuit 60 can include multiple segments that have different characteristics. For example, a first segment 62 of the flex circuit 60 can support the sensor 70. The first segment 62 can defined a terminal and portion of the flex circuit 60 for residing within the enclosure of the sensor assembly 10. The flex circuit 60 can further include a second segment 64 that extends from the first segment 62 and/or within the enclosure. The second segment 64 can provide strain relief features, such as a shape and/or size that promotes flexibility, bending, and/or stretching. For example, as shown in FIG. 2, the second segment 64 can include an S-curve, a serpentine shape, an undulating shape, and/or another non-linear shape. With such a shape, the second segment 64 can easily alter it shape upon application of tension and/or other forces along the length of the flex circuit 60. For example, tension and/or other forces applied at a third segment 66 of the flex circuit 60 that is away from the sensor 70 (e.g., within or outside the enclosure) can be absorbed by adjustments along the second segment 64, such that such tension and/or other forces are not transmitted to the sensor 70. Such adjustments can include an adjustment to the effective length of the second segment 64 (e.g., between the first segment 62 and the third segment 66), adjustments to the curvature along the second segment 64, and the like. By further example, the second segment 64 can alter its shape along and/or about one or more axes extending through the second segment 64. As such, the sensor 70 can maintain a consistent position and/or orientation despite the application of external forces.

A base plate 80 can provide support to the sensor 70 and the flex circuit 60. For example, the base plate 80 can be disposed adjacent to the sensor 70 on a side of the flex circuit 60 that is opposite the sensor 70. Additionally or alternatively, the flex circuit 60 can be or include a circuit board that provides a rigid substrate with electrical connections between components and/or to other components. Where the flex circuit 60 includes or forms a rigid circuit board, the base plate 80 can optionally be omitted.

The sensor assembly 10 can further include a mounting adhesive 50 disposed between the base plate 80 and the bottom plate 112. The mounting adhesive 50 can bond opposing surfaces of the base plate 80 and the bottom plate 112 to each other. The mounting adhesive 50 can have a coefficient of thermal expansion that is complementary to the coefficients of thermal expansion of the base plate 80 and/or the bottom plate 112 to minimize strain on the sensor 70. As used herein, a coefficient of thermal expansion can refer to either a linear coefficient of thermal expansion and/or a volumetric coefficient of thermal expansion. As used herein, any two coefficients of thermal expansion are “complementary” when one is within ±20%, ±15%, ±10%, ±9%, ±8%, ±7%, ±6%, ±5%, ±4%, ±3%, ±2%, or ±1% of the other, inclusive of any intermediate value there between. For example, the mounting adhesive 50 can have a coefficient of thermal expansion that is within ±10%, ±9%, ±8%, ±7%, ±6%, ±5%, ±4%, ±3%, ±2%, or ±1% of the coefficient of thermal expansion of the base plate 80 and/or the bottom plate 112.

The top case 20 defines an opening 28 to permit electrical communication with the sensor 70, for example, at a side portion 22 of the top case 20. For example, the flex circuit 60 (e.g., at the third segment 66 thereof) can extend through the opening 28, so that a connector 68 at a terminal end of the flex circuit 60 (e.g., at an end opposite the sensor 70 and the first segment 62) can connect to another component. The connector 68 coupled to the flex circuit 60 can be in electrical or other operably communication with the sensor 70. As such, the connector 68 can operably connect the sensor 70 to another component, such as a controller of the head-mountable device.

The sensor assembly 10 further includes a sealing member 52 disposed within the opening 28 to seal the enclosure from an external environment and permit electrical communication with the sensor 70 along the flex circuit 60. For example, the sealing member 52 can entirely surround a portion of the flex circuit 60 (e.g., along the third segment 66). The flex circuit 60 can extend entirely through the sealing member 52 to extend to either side thereof, such as to the interior and exterior of the enclosure. The sealing member 52 can include an adhesive, silicone, and/or other sealing member. The sealing member 52 can be provided as a liquid that solidifies (e.g., cures) during assembly.

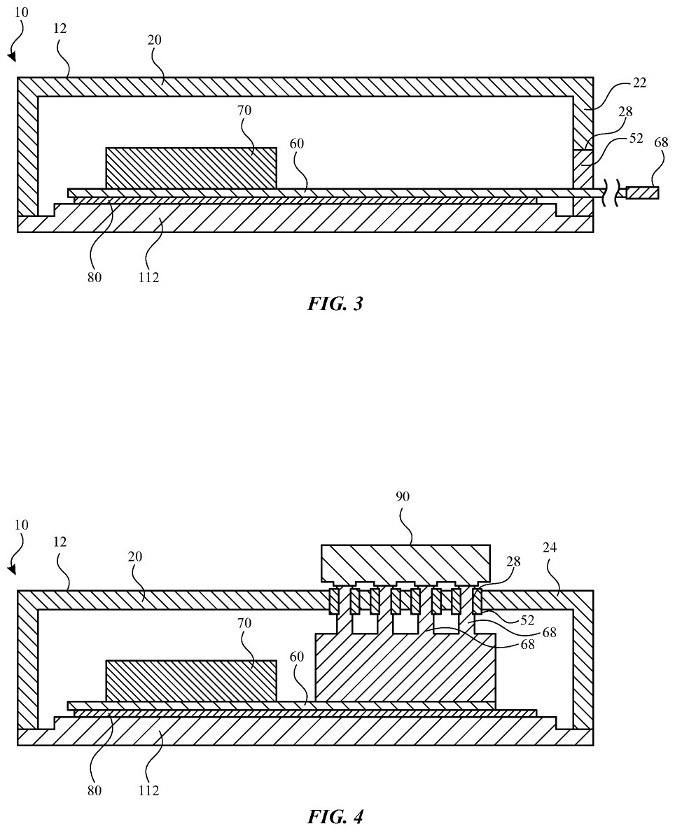

As shown in FIG. 3, the sensor assembly 10 can form an enclosure 12 to house the sensor 70 (e.g., IMU). For example, the top case 20, the bottom plate 112, and the sealing member 52 can form a sealed enclosure 12 that surrounds a sealed volume. The sensor 70, the base plate 80, and a portion of the flex circuit 60 can be contained within the sealed volume.

To form the enclosure 12, the top case 20 can be coupled to the bottom plate 112 in a sealing manner. For example, the top case 20 can be welded (e.g., laser welded) to the bottom plate 112. Other types of couplings are contemplated, such as bonding, adhesion, and the like. The coupling can maintain the opening 28, for example at a side portion 22 of the top case 20.

The flex circuit 60, including the connector 68, can be provided through the opening 28. The sealing member 52 can be formed about a portion of the flex circuit 60 that extends through the opening 28. The sealing member 52 can extend from the top case 20 to the bottom plate 112. As such, the sealing member 52 can fill the only opening 28 that provides fluid communication between the interior of the enclosure 12 and an external environment (e.g., exterior to the enclosure 12).

As further shown in FIG. 3, the opening 28 can be defined on a side portion 22 of the top case 20. It will be understood that the opening 28 can be provided at any portion of the top case 20, as described further herein. Regardless of its location, the opening 28 can be filled with the sealing member 52 and around the flex circuit 60.

By coupling the top case 20 to the bottom plate 112 and by filling the opening 28 with the sealing member 52, the enclosure 12 can provide a sealed volume for the sensor 70. As used herein, and enclosure, volume, or other space that is “sealed” is at least partially and/or selectively isolated from an external environment. For example, the top case 20 and the bottom plate 112 can be impermeable, such that they form a barrier against ingress and/or egress of matter there through. The sealing member 52 can also form a barrier. It will be understood that one or more barriers can be selectively permeable while still maintaining a sealed volume and/or enclosure. For example, the sealing member 52 can be permeable to one or more gases and/or substances on an atomic level. However, the sealing member 52 can be impermeable to (e.g., preventing ingress or egress of) molecules, compounds, and/or liquids. In some embodiments, the enclosure can be hermetically or “airtight” sealed, however other seals are contemplated.

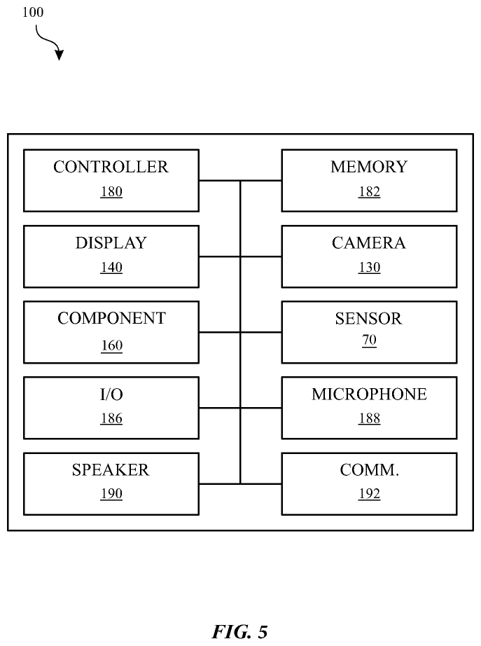

As shown in FIG. 4, the connector 68 can extend through other portions of the top case 20, such as an upper portion 24 of the top case 20. The upper portion 24 can be a portion of the top case that is opposite the bottom plate 112. One or more openings 28 can be defined on the upper portion 24 of the top case 20, and corresponding connectors 68 can extend through the openings 28. Outside of the enclosure 12, a mating connector 90 can be operably coupled to the connectors 68. For example, the interface between the mating connector 90 and the connector(s) 68 can include one or more electrodes, contact plates, wires, pogo pins, and the like.

Where the connectors 68 extend through the opening 28, one or more sealing members 52 can be formed to fill the openings 28 and surround corresponding portions of the connectors 68. Where the openings are formed in the upper portion 24 of the top case 20, the sealing members 52 need not engage the bottom plate 112. As such, the top case 20 and the bottom plate 112 can be coupled with a continuous seal, such as a weld.

It will be understood that the opening(s) 28 can be provided at any portion of the top case 20 and/or the bottom plate 112. Regardless of its location, the opening 28 can be filled with the sealing member 52 and around the flex circuit 60 and/or connector(s) 68.

Sensor assemblies of the present disclosure can provide predictable performance over the life of the head-mountable device by isolating the sensor from strain and humidity changes. This can enables absolute orientation measurements between multiple sensors over the life of the head-mountable device, without requiring repeated calibration. By providing each sensor (e.g., IMU) in a consistent position and orientation, any one or multiple sensors can be dedicated as a reference sensor for the entire head-mountable device.

Referring now to FIG. 5, components of the head-mountable device can be operably connected to provide the performance described herein. FIG. 5 shows a simplified block diagram of an illustrative head-mountable device 100 in accordance with one embodiment of the invention. It will be appreciated that components described herein can be provided on either or both of a frame and/or a head engager of the head-mountable device 100. It will be understood that additional components, different components, or fewer components than those illustrated may be utilized within the scope of the subject disclosure.

As shown in FIG. 5, the head-mountable device 100 can include a controller 180 (e.g., control circuitry) with one or more processing units that include or are configured to access a memory 182 having instructions stored thereon. The instructions or computer programs may be configured to perform one or more of the operations or functions described with respect to the head-mountable device 100. The controller 180 can be implemented as any electronic device capable of processing, receiving, or transmitting data or instructions. For example, the controller 180 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 182 can store electronic data that can be used by the head-mountable device 100. The memory 182 can include the memory of the flex circuit 170 described herein. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDS, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 100 can include an optical subassembly configured to help optically adjust and correctly project the image-based content being displayed by the display 140 for close up viewing. The optical subassembly can include one or more lenses, mirrors, or other optical devices.

The head-mountable device 100 can include one or more sensors 70, such as the sensors of a sensor assembly, as described herein. The head-mountable device 100 can include one or more other sensors, including sensors of a sealed enclosure assembly and/or other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include a camera which can capture image based content of the outside world.

The head-mountable device 100 can include an input/output component 186, which can include any suitable component for connecting head-mountable device 100 to other devices. Suitable components can include, for example, audio/video jacks, data connectors, or any additional or alternative input/output components. The input/output component 186 can include buttons, keys, or another feature that can act as a keyboard for operation by the user.

The head-mountable device 100 can include the microphone 188 as described herein. The microphone 188 can be operably connected to the controller 180 for detection of sound levels and communication of detections for further processing, as described further herein.

The head-mountable device 100 can include the speakers 190 as described herein. The speakers 190 can be operably connected to the controller 180 for control of speaker output, including sound levels, as described further herein.

The head-mountable device 100 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHZ, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 100 can include a battery, which can charge and/or power components of the head-mountable device 100. The battery can also charge and/or power components connected to the head-mountable device 100.

While various embodiments and aspects of the present disclosure are illustrated with respect to a head-mountable device, it will be appreciated that the subject technology can encompass and be applied to other devices. For example, a sensor assembly in accordance with embodiments disclosed herein can be included with an electronic device that is moved while in use. Such an electronic device can be or include a desktop computing device, a laptop-computing device, a display, a television, a portable device, a phone, a tablet computing device, a mobile computing device, a wearable device, a watch, and/or a digital media player.

Accordingly, embodiments of the present disclosure provide a head-mountable device that securely supports sensors in a manner that maintains their positions and orientations over time and avoids applying excessive strain on the sensors, thereby protecting them from harm. Accordingly, the sensor assemblies described herein facilitate effective performance of sensors mounted therein. The sensor assemblies provides high robustness during the entirety of the service life of the head-mountable device without placing strain on the sensors themselves. The seal of the enclosure can isolate the sensor from external influences by preventing ingress of elements through the case and plate. The sensor assemblies further enable the mounting of sensors on a flex circuit, where desired.

Various examples of aspects of the disclosure are described below as clauses for convenience. These are provided as examples, and do not limit the subject technology.
Clause A: a sensor assembly for a head-mountable device, the sensor assembly comprising: a flex circuit; an inertial measurement unit coupled to the flex circuit; a base plate disposed adjacent to the inertial measurement unit on a side of the flex circuit that is opposite the inertial measurement unit; and an enclosure disposed around the inertial measurement unit, the base plate, and a portion of the flex circuit, wherein the enclosure comprises: a top case; and a bottom plate coupled to the top case, wherein the bottom plate and the top case are positioned to define a sealed volume containing the inertial measurement unit, the base plate, and the portion of the flex circuit.
Clause B: a sensor assembly for a head-mountable device, the sensor assembly comprising: a flex circuit; an inertial measurement unit coupled to the flex circuit; an enclosure disposed around the inertial measurement unit and a first portion of the flex circuit, wherein the enclosure defines an opening, wherein a second portion of the flex circuit extends through the opening to permit electrical communication with the inertial measurement unit; and a sealing member disposed within the opening and around the second portion of the flex circuit to seal the enclosure from an external environment.
Clause C: a sensor assembly for a head-mountable device, the sensor assembly comprising: a flex circuit; an inertial measurement unit coupled to the flex circuit; a connector in electrical communication with the inertial measurement unit and coupled to the flex circuit; an enclosure disposed around the inertial measurement unit and the flex circuit, wherein the enclosure defines an opening, wherein the connector extends through the opening to permit electrical communication with the inertial measurement unit; and a sealing member disposed within the opening and around the connector to seal the enclosure from an external environment.

One or more of the above clauses can include one or more of the features described below. It is noted that any of the following clauses may be combined in any combination with each other, and placed into a respective independent clause, e.g., clause A, B, or C.
Clause 1: the inertial measurement unit comprises an accelerometer, a gyroscope, or a magnetometer.
Clause 2: the top case defines an opening to permit electrical communication with the inertial measurement unit.
Clause 3: the flex circuit extends through the opening in the top case.
Clause 4: a connector coupled to the flex circuit and in electrical communication with the inertial measurement unit, wherein the connector extends through the opening in the top case.
Clause 5: the opening is defined on a side portion of the top case.
Clause 6: the opening is defined on an upper portion of the top case.
Clause 7: a sealing member disposed within the opening to seal the enclosure from an external environment and permit electrical communication with the inertial measurement unit.
Clause 8: the sealing member comprises a sealing adhesive or silicone.
Clause 9: a mounting adhesive disposed between the base plate and the bottom plate, wherein the mounting adhesive has a coefficient of thermal expansion that is complementary to a coefficient of thermal expansion of the top case and the bottom plate to minimize strain on the inertial measurement unit.
Clause 10: the inertial measurement unit is mounted to the flex circuit extending entirely through the enclosure.
Clause 11: the first portion of the flex circuit within the enclosure defines an S-curve portion.
Clause 12: the connector comprises a plurality of pins extending through the sealing member.

As described above, one aspect of the present technology may include the gathering and use of data. The present disclosure contemplates that in some instances, this gathered data may include personal information or other data that uniquely identifies or can be used to locate or contact a specific person. The present disclosure contemplates that the entities responsible for the collection, disclosure, analysis, storage, transfer, or other use of such personal information or other data will comply with well-established privacy policies and/or privacy practices. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A sensor assembly for a head-mountable device, the sensor assembly comprising:
a flex circuit;
an inertial measurement unit coupled to the flex circuit;
a base plate disposed adjacent to the inertial measurement unit on a side of the flex circuit that is opposite the inertial measurement unit; and
an enclosure disposed the inertial around measurement unit, the base plate, and a portion of the flex circuit, wherein the enclosure comprises:
a top case; and
a bottom plate coupled to the top case, wherein the bottom plate and the top case are positioned to define a sealed volume containing the inertial measurement unit, the base plate, and the portion of the flex circuit.

2. The sensor assembly of claim 1, wherein the inertial measurement unit comprises an accelerometer, a gyroscope, or a magnetometer.

3. The sensor assembly of claim 1, wherein the top case defines an opening to permit electrical communication with the inertial measurement unit.

4. The sensor assembly of claim 3, wherein the flex circuit extends through the opening in the top case.

5. The sensor assembly of claim 3, further comprising a connector coupled to the flex circuit and in electrical communication with the inertial measurement unit, wherein the connector extends through the opening in the top case.

6. The sensor assembly of claim 3, wherein the opening is defined on a side portion of the top case.

7. The sensor assembly of claim 3, wherein the opening is defined on an upper portion of the top case.

8. The sensor assembly of claim 3, further comprising a sealing member disposed within the opening to seal the enclosure from an external environment and permit electrical communication with the inertial measurement unit.

9. The sensor assembly of claim 8, wherein the sealing member comprises a sealing adhesive or silicone.

10. The sensor assembly of claim 1, further comprising a mounting adhesive disposed between the base plate and the bottom plate, wherein the mounting adhesive has a coefficient of thermal expansion that is complementary to a coefficient of thermal expansion of the top case and the bottom plate to minimize strain on the inertial measurement unit.

11. A head-mountable device comprising:
a frame;
a display movably coupled to the frame; and
the sensor assembly of claim 1, wherein the sensor assembly is coupled to the display.

12. A sensor assembly for a head-mountable device, the sensor assembly comprising:
a flex circuit;
an inertial measurement unit coupled to the flex circuit;
an enclosure disposed around the inertial measurement unit and a first portion of the flex circuit, wherein the enclosure defines an opening, wherein a second portion of the flex circuit extends through the opening to permit electrical communication with the inertial measurement unit; and
a sealing member disposed within the opening and around the second portion of the flex circuit to seal the enclosure from an external environment.

13. The sensor assembly of claim 12, wherein the inertial measurement unit is mounted to the flex circuit extending entirely through the enclosure.

14. The sensor assembly of claim 12, wherein the sealing member comprises a sealing adhesive or silicone.

15. The sensor assembly of claim 12, wherein the first portion of the flex circuit within the enclosure defines an S-curve portion.

16. A sensor assembly for a head-mountable device, the sensor assembly comprising:
a flex circuit;
an inertial measurement unit coupled to the flex circuit;
a connector in electrical communication with the inertial measurement unit and coupled to the flex circuit;
an enclosure disposed around the inertial measurement unit and the flex circuit, wherein the opening, wherein the connector enclosure defines an extends through the opening to permit electrical communication with the inertial measurement unit; and
a sealing member disposed within the opening and around the connector to seal the enclosure from an external environment.

17. The sensor assembly of claim 16, wherein the connector comprises a plurality of pins extending through the sealing member.

18. The sensor assembly of claim 16, wherein the opening is defined on a side portion of the top case.

19. The sensor assembly of claim 16, wherein the opening is defined on an upper portion of the top case.

20. The sensor assembly of claim 16, wherein the sealing member comprises a sealing adhesive or silicone.
